(19) United States
(12) Patent Application Publication
(10) Pub. No.: US 2013/0001011 A1
(43) Pub. Date: Jan. 3, 2013

(54) SOUND MUFFLING APPARATUS AND METHOD OF USING SAME

(76) Inventor: John Charles Panosh, Charlotte, NC (US)

(21) Appl. No.: 13/341,919

(22) Filed: Dec. 31, 2011

Related U.S. Application Data
(63) Continuation-in-part of application No. 13/005,092, filed on Jan. 12, 2011, now abandoned.

(51) Int. Cl. G10K 11/16

(52) U.S. Cl. 181/287; 181/296

(57) ABSTRACT

An apparatus for muffling sound can include first and second pivotally connected panels, each of the panels having a front side, a back side opposite the front side, a bottom edge for positioning on a base surface, and a top edge opposite the bottom edge. The panels can be moveable between an open position for use and a closed position for transport, and have complementary sections of sound dampening material, such as a plurality of foam pyramids. The foam pyramids can be positioned on the panels such that they are positioned against each other in an interlocking arrangement when the panels are in the closed position.

This application is a continuation-in-part of U.S. application Ser. No. 13/005,092, filed Jan. 12, 2011. The present invention relates to an apparatus that can be used to soften or muffle the sound emanating from an electric amplifier, such as a guitar or bass amplifier. In one embodiment of the invention, the apparatus can be folded into a carrying position for easy transport.

### TECHNICAL FIELD AND BACKGROUND OF THE INVENTION

It is common to have live music performed in restaurants, cafes, coffee shops and small clubs. Such music typically includes musicians playing electric guitars, bass guitars and keyboards through amplifiers. While the audience enjoys having the live music, patrons in such intimate settings typically do not want the music to be so loud as to make it difficult for them to carry on conversation with others at their table. Furthermore, patrons sitting in the direct line of the amplifiers typically are receiving volumes at a much higher level than others seated around the periphery of the amplifiers.

As such, merely turning down the volume on the musician's amplifiers generally does not provide a satisfactory solution to this problem. While those seated in the direct line of the amplifiers may get relief from excessive volumes, those seated along the periphery may then not be able to hear adequately. Furthermore, a certain level of volume is often necessary for the sound to have a desired quality, particularly for rock and roll music, and reducing the volume below that level can result in an unsatisfactory sound quality. Also, reducing the volume of the amplifiers makes it difficult for the musicians to adequately hear their own instruments, particularly in noisy environments, such as restaurants and bars.

### SUMMARY OF THE INVENTION

Therefore, one object of the present invention is to provide an apparatus that can muffle the sound produced from electric amplifiers for audience members seated close to the amplifiers. Another object of the invention is to provide a sound muffling apparatus that is easily transportable.

These and other objects of the present invention can be achieved in the preferred embodiments of the invention described below, in which one embodiment comprises an apparatus for muffling sound comprising first and second pivotally connected panels, each of the panels having a front side, a back side opposite the front side, and a bottom edge for positioning on a base surface. Sound dampening material is attached to the front side of each of the first and second panels, and a first foot section is functionally connected to the first panel and extends to the base surface to support the panels in an upright position in relation to the base surface.

According to another embodiment of the invention, a second foot section can be attached to the second panel and extends to the base surface to support the panels in an upright position in relation to the base surface.

According to another embodiment of the invention, the first foot section extends substantially perpendicularly from the bottom edge of the first panel, and the second foot section extends substantially perpendicularly from the bottom edge of the second panel.

According to another embodiment of the invention, the first foot is pivotally connected to the bottom edge of the first panel, and the second foot is pivotally connected to the bottom edge of the second panel. As such, the first and second foot sections are moveable from a transport position in which the foot sections are substantially parallel to the first and second panels, to a standing position in which the foot sections extend substantially perpendicularly from the back side of the first and second panels.

According to another embodiment of the invention, a handle section can be functionally connected to the first panel for a user to grip the apparatus when in the transport position.

According to another embodiment of the invention, the first panel includes an inner side edge, the second panel includes an inner side edge, and the inner side edge of the first panel is pivotally connected to the inner side edge of the second panel.

According to another embodiment of the invention, the first panel includes an outer side edge opposite the inner side edge, and a first handle section is functionally connected to the outer side edge.

According to another embodiment of the invention, the second panel includes an outer side edge opposite the inner side edge, and a second handle section is functionally connected to the outer side edge of the second panel.

According to another embodiment of the invention, the sound dampening material is comprised of sound absorbing foam.

According to another embodiment of the invention, the first foot section is pivotally connected to the bottom edge of the first panel, such that the first foot section is moveable between a transport position in which the foot section is substantially parallel to the first panel, and a standing position in which the foot section is substantially perpendicular to the first panel.

According to another embodiment of the invention, a second foot section is pivotally connected to the bottom edge of the second panel, such that the second foot section is moveable between a transport position in which the second foot section is substantially parallel to the second panel, and a standing position in which the second foot section is substantially perpendicular to the first panel.

According to another embodiment of the invention, an apparatus for muffling sound emanating from an electric amplifier comprises first and second pivotally connected panels, each of the panels having a front side, a back side opposite the front side, and a bottom edge for positioning on a base surface. Sound dampening material is attached to the front side of each of the first and second panels, a first foot section is pivotally connected to the bottom edge of the first panel, and a second foot section is pivotally connected to the bottom edge of the second panel. The first and second foot sections are moveable from a transport position in which the foot sections are substantially parallel to the first and second panels, to a standing position in which the foot sections extend substantially perpendicularly from the back side of the first and second panels for supporting the panels in an upright position on the base surface.

According to another embodiment of the invention, the sound dampening material comprises a first foam section attached to the front side of the first panel, and a second foam section attached to the front side of the second panel.

According to another embodiment of the invention, at least a portion of the first foam section is co-planar with the bottom edge of the first panel such that the first foam section helps support the panels when in the upright position on the base surface.

According to another embodiment of the invention, at least a portion of the second foam section is co-planar with the bottom edge of the second panel such that the second foam section helps support the panels when in the upright position on the base surface.

According to another embodiment of the invention, the first panel and the second panel each includes an inner side edge and an outer side edge opposite to the inner side. The inner side edge of the first panel is pivotally connected to the inner side edge of the second panel, and a first handle section is functionally connected to the outer side edge of the first panel, and a second handle section is functionally connected to the outer side edge of the second panel.

According to another embodiment of the invention, a method for muffling the sound emanating from an electric amplifier comprises providing a sound muffling apparatus comprising first and second pivotally connected panels, each of the panels having a front side, a back side opposite the front side, and a bottom edge for positioning on a base surface. The panels are moveable between a closed position in which the front side of each of the panels are flat against each other, and an open position in which the front side of the panels are exposed. A handle is connected to the first panel, and sound dampening material is attached to the front side of each of the first and second panels. A first foot section is pivotally connected to the bottom edge of the first panel, and a second foot section is pivotally connected to the bottom edge of the second panel, such that the first and second foot sections are moveable from a transporting position in which the foot sections are substantially parallel to the first and second panels, to a standing position in which the foot sections extend substantially perpendicularly from the back side of the first and second panels. An electric amplifier is positioned on a base surface. The bottom edges of the first and the second panels are positioned on the base surface proximate the amplifier, with the front side of each of the panels facing the amplifier. The first and second panels are placed in an open position, in which the front sides of the first and second panels define an angle of less than 180 degrees. The first and second foot sections are moved to the standing position, so that the first and second panels are supported in an upright position on the base surface.

According to another embodiment of the invention, the first and second foot sections can be moved to the transporting position, and the first panel and the second panels are moved to the closed position. The user can grasp the handle, and transports the sound muffling apparatus to a desired location.

### BRIEF DESCRIPTION OF THE DRAWINGS

FIG. 1 is a perspective view of a sound muffling apparatus according to a preferred embodiment of the invention;

FIG. 2 is another perspective view of the sound muffling apparatus of FIG. 1;

FIG. 3 is another perspective view of the sound muffling apparatus of FIG. 1;

FIG. 4 is another perspective view of the sound muffling apparatus of FIG. 1;

FIG. 5 is an environmental view illustrating a use of the sound muffling apparatus of FIG. 1 according to a preferred embodiment of the invention;

FIG. 6 is another environmental view of the sound muffling apparatus of FIG. 1;

FIG. 7 is a perspective view of a sound muffling apparatus according to another embodiment of the invention;

FIG. 8 is an environmental view of the sound muffling apparatus of FIG. 7, illustrating use of the sound muffling apparatus with a second apparatus; and

FIG. 9 is a top perspective view of the sound muffling apparatus of FIG. 7.

### DESCRIPTION OF THE PREFERRED EMBODIMENTS OF THE INVENTION AND BEST MODE

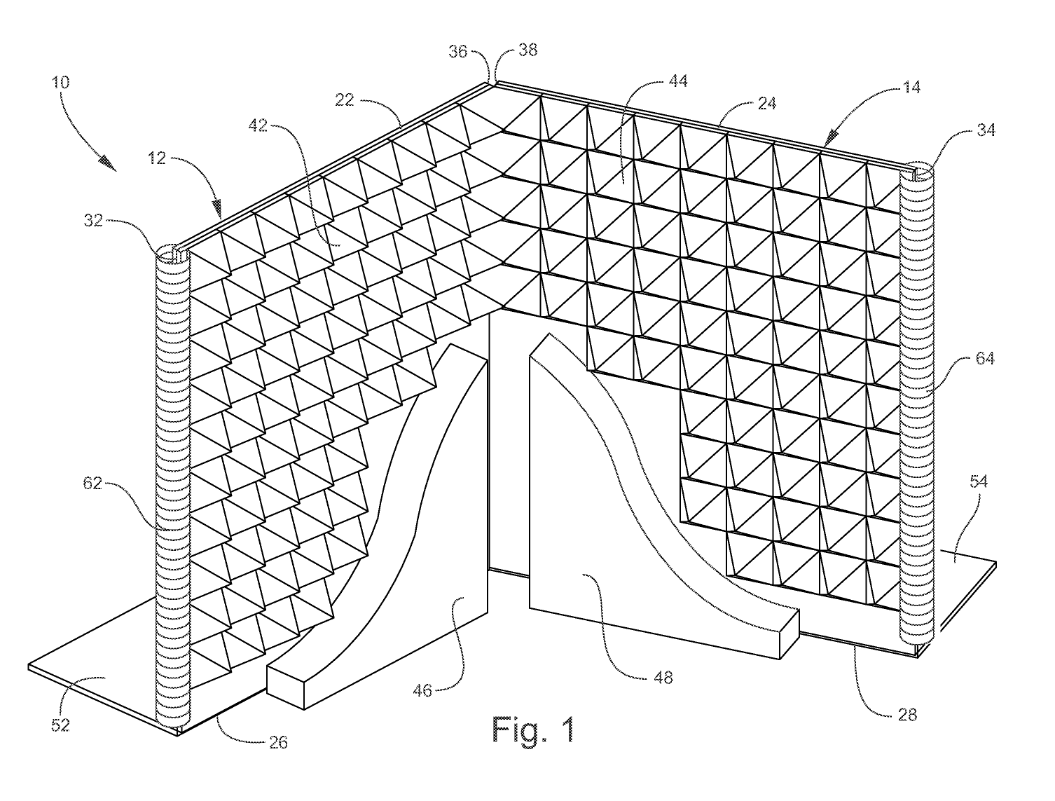

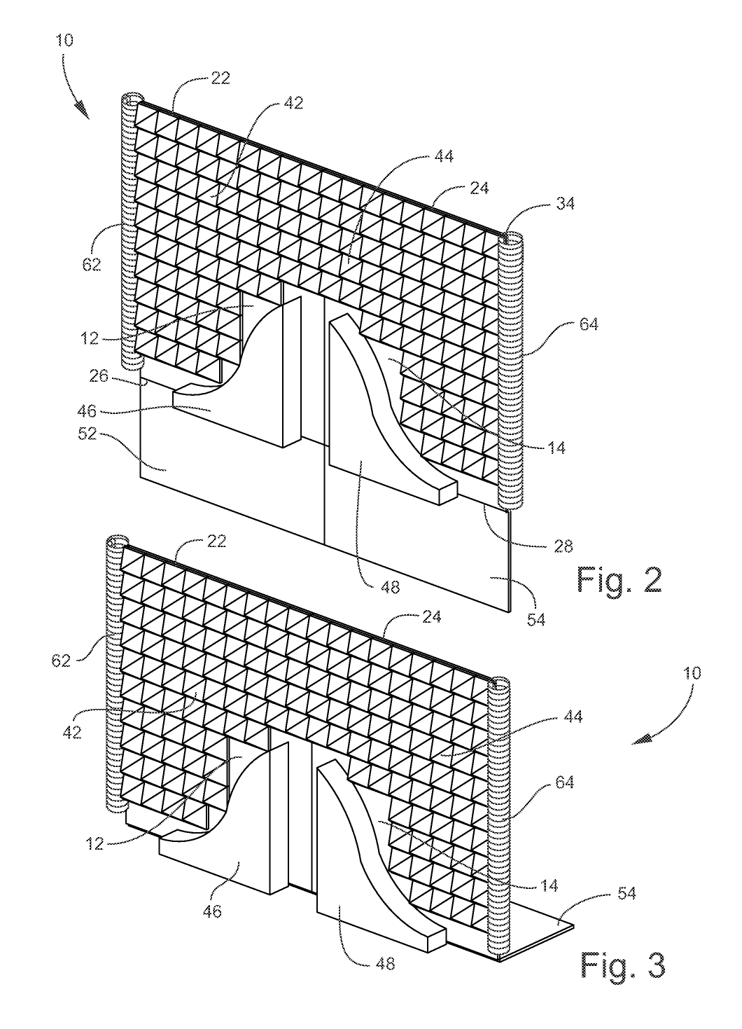

A sound muffling apparatus according to a preferred embodiment of the invention is illustrated in FIGS. 1-4, and shown generally at reference numeral 10. As shown in FIGS. 1 and 2, the apparatus 10 comprises two panels 12, 14 pivotally joined along a vertical axis. The panels 12, 14 respectively include top edges 22, 24, base edges 26, 28 opposite to the top edges 22, 24, outer edges 32, 34, and inner edges 36, 38 opposite to the outer edges 32, 34. The panels 12, 14 can be pivotally connected at their inner edges 36, 38 by hinges, or other suitable attachment means. The panels 12, 14 can be made of plastic, cardboard or other suitable material.

A sound absorbing material is positioned on the front face of each panel 12, 14. Preferably, the sound absorbing material is comprised of two sections 42, 44 of sound absorbing foam, such as the acoustic foam sold by AURALEX, having the shape of a plurality of pyramids. In addition, the sound absorbing material preferably includes sound absorbing foam units 46, 48, positioned on the front face of the panels 12, 14, respectively. As shown in FIGS. 2 and 3, the base of the foam units 46, 48 is co-planar with the base edges 26, 28, respectively, of the panels 12, 14, and extend outwardly from the front face of the panels 12, 14.

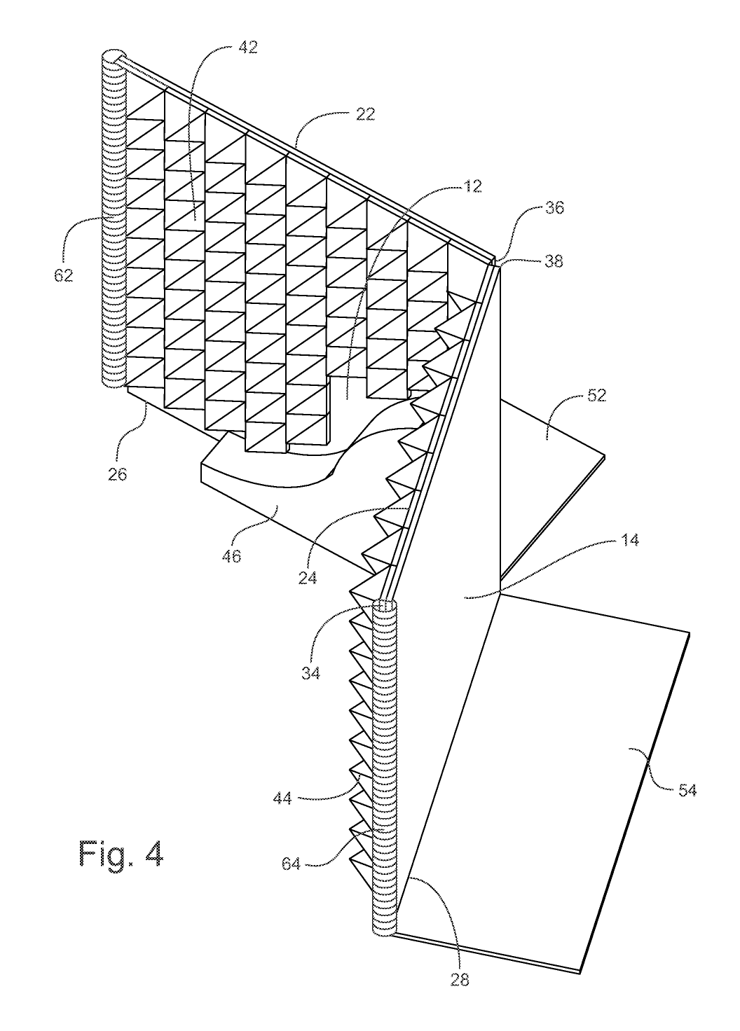

Foot sections 52, 54 are pivotally connected at the base edges of the panels 12, 14, respectively. As such, the foot sections 52, 54 can be moved from a position in which the foot sections 52, 54 extend outward from the panels at approximately 180 degrees, as shown in FIG. 2, to a position in which the foot sections 52, 54 extend outwardly from the rear surface of the panels 12, 14 at an approximately 90 degree angle, as shown in FIGS. 3 and 4. The foot sections 52, 54 can be made of plastic, cardboard or other suitable material. Alternatively, base sections can be designed to be pulled down from the panels 12, 14 and twisted to into a position laying flat on the floor.

Handle sections 62, 64, which can be comprised of plastic ribbed tubing, can be attached at the outer edges 32, 34 of the panels 12, 14. Alternatively, a conventional handle can be attached to either of the outer edges 32, 34.

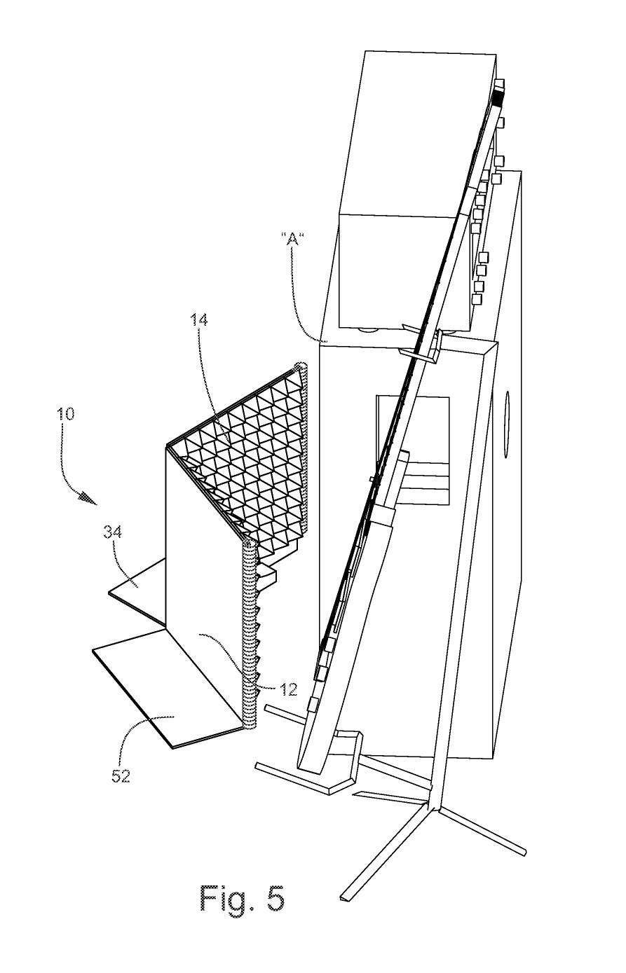

In a preferred method of using the apparatus 10, the panels 12, 14 are positioned at a slight angle to each other, such that the front faces of the panels 12, 14 define an obtuse angle, and the foot sections 52, 54 are positioned outwardly from the rear surface of the panels 12, 14 to lie flat on the floor, as shown in FIG. 1. In this standing position, the foam units 46, 48 help to maintain the apparatus in an upright position and prevent the panels 12, 14 from falling forward. The apparatus 10 can be positioned in front of an electric amplifier “A”, as shown in FIG. 5, with the sound dampening material on the front face of the panels 12, 14 facing the amplifier “A” to muffle the sound emanating from the amplifier. The apparatus 10 softens the volume and attack of the sound coming from the electric amplifier for audience members sitting in the direct line of the amplifier, thereby making the performance generally more pleasing for audiences in intimate settings such as restaurants.

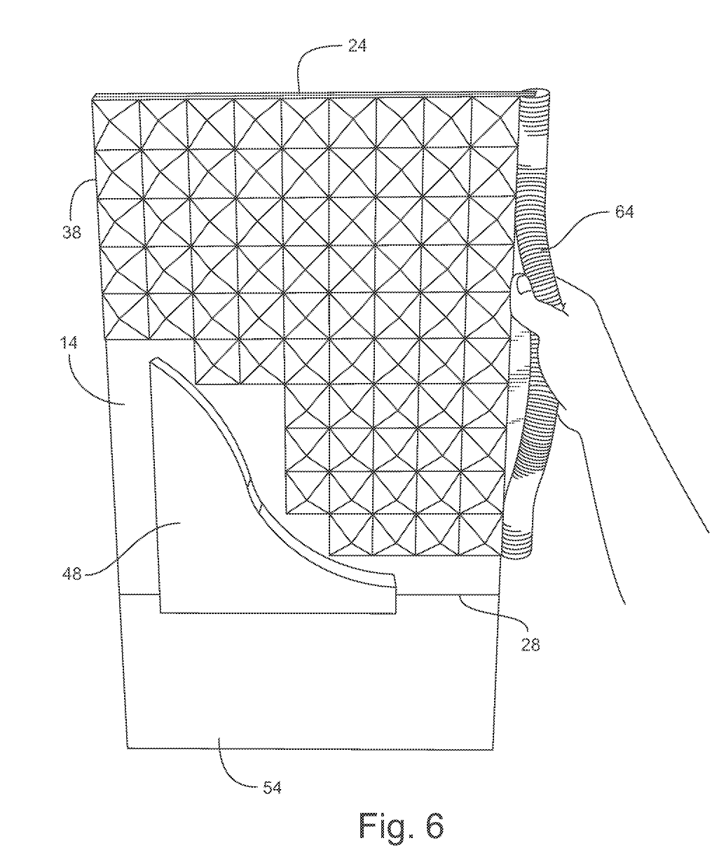

When the musician is done performing, the foot sections 52, 54 are moved to a substantially parallel position with the panels 12, 14, as shown in FIG. 2, and the panels 12, 14 are folded such that the rear surfaces of the panels 12, 14 lie flat against each other, as shown in FIG. 6. In this transport position, the user can grasp the handle sections 62, 64, and carry the apparatus 10 to a desired place for storage until the next performance.

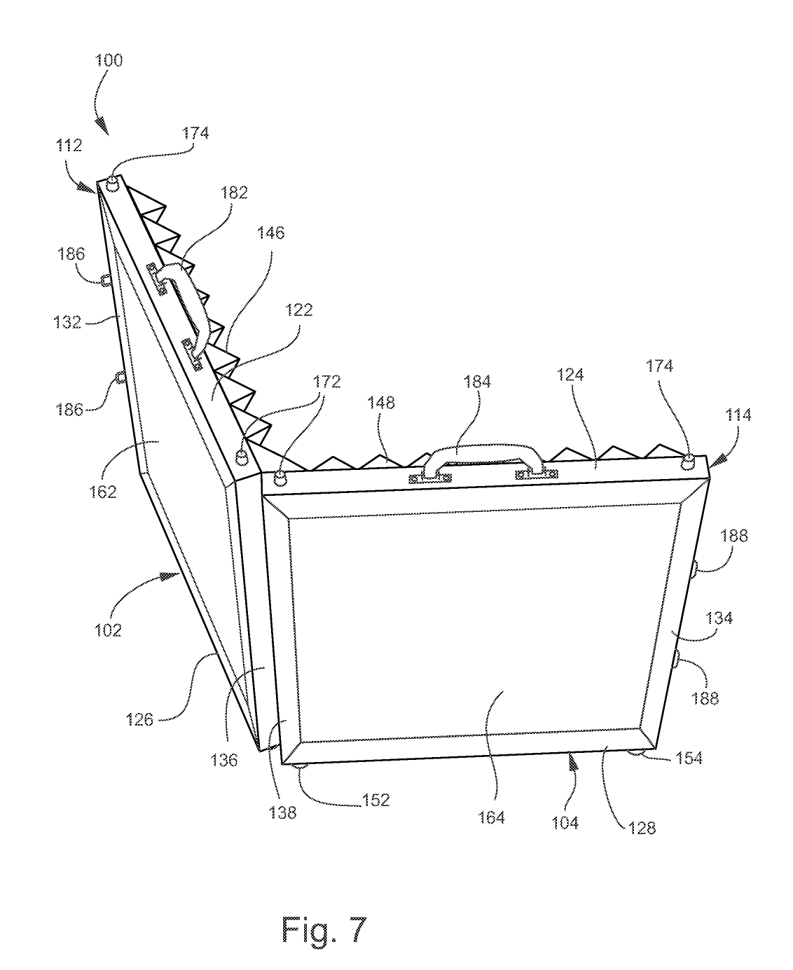

A sound muffling apparatus according to another embodiment of the invention is illustrated in FIGS. 7-9, and shown generally at reference numeral 100. The apparatus 100 comprises two panels 102, 104 pivotally joined along a vertical axis. The panels 102, 104 can be comprised of rectangular frames 112, 114, respectively, and support sections 162, 164 contained within the frames 112, 114, respectively. The panels 112, 114 respectively include top sections 122, 124, base sections 126, 128 opposite to the top sections 122, 124, outer sections 132, 134, and inner sections 136, 138 opposite to the outer sections 132, 134. The frames 112, 114 are pivotally connected at their inner sections 136, 138 by hinges 160. The frames 112, 114 are preferably made of extruded angled aluminum having dimensions of about 1.500×1.500×0.0625 inches. Alternatively, the frames 112, 114 can be made of ribbed aluminum, or other suitable material. The support sections 162, 164 are preferably made of pressed hardboard having a thickness of about 0.25 inch. Alternatively, the support sections 162, 164 can be made of plastic, carbon fiber, other suitable material. The pressed hardboard sections 162, 164 can be attached to the frames 112, 114 by aluminum pop rivets 166.

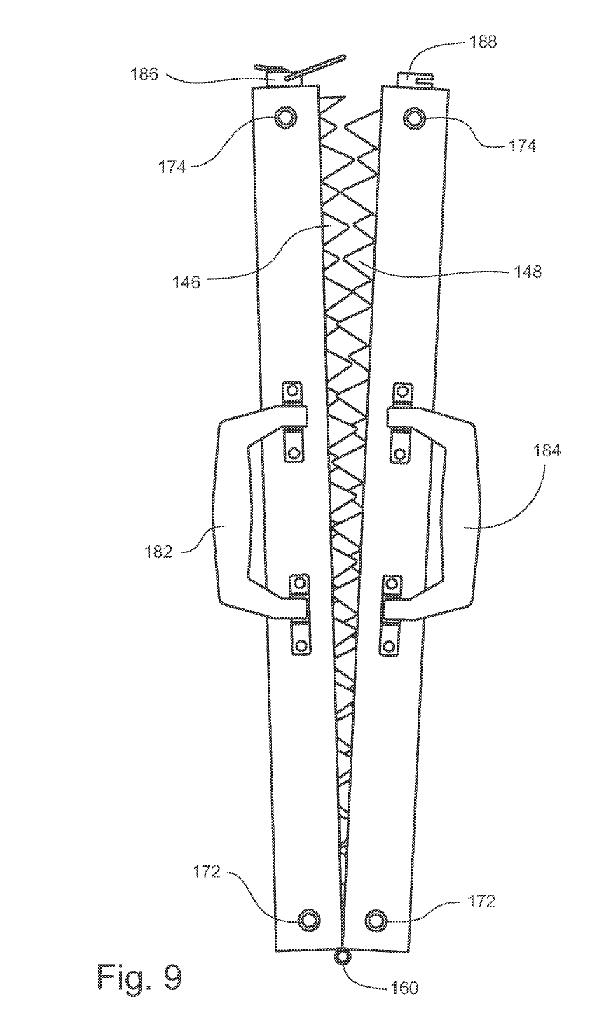

Sound absorbing foam sections 146, 148 are positioned on the front face of the pressed hardboard support sections 162, 164 of the panels 102, 104. Preferably, the foam sections 146, 148 comprise foam pyramids having a height of about two inches. The foam sections 146, 148 are positioned such that the pyramids on the respective sections 146, 148 interlock with each other when the panels 102, 104 are closed together, as shown in FIG. 9. This facilitates compact closing of the apparatus 100 for convenient transport.

A plurality of foot sections 152, 154 are positioned on the base sections 126, 128 of the frames 112, 114 of the panels 102, 104. Each of the foot sections 152, 154 is comprised of a rounded rubber foot piece. Each of the base sections 126, 128 of the frames 112, 114 can have a pair of rounded rubber feet 152, 154, positioned thereon, for a total four feet 152, 154 on the apparatus 100. The rubber feet 152, 154 provide relatively soft and resilient surface for supporting the apparatus 100, and prevents scratching of the frame 112, 114 against the ground or floor on which the apparatus 100 is placed.

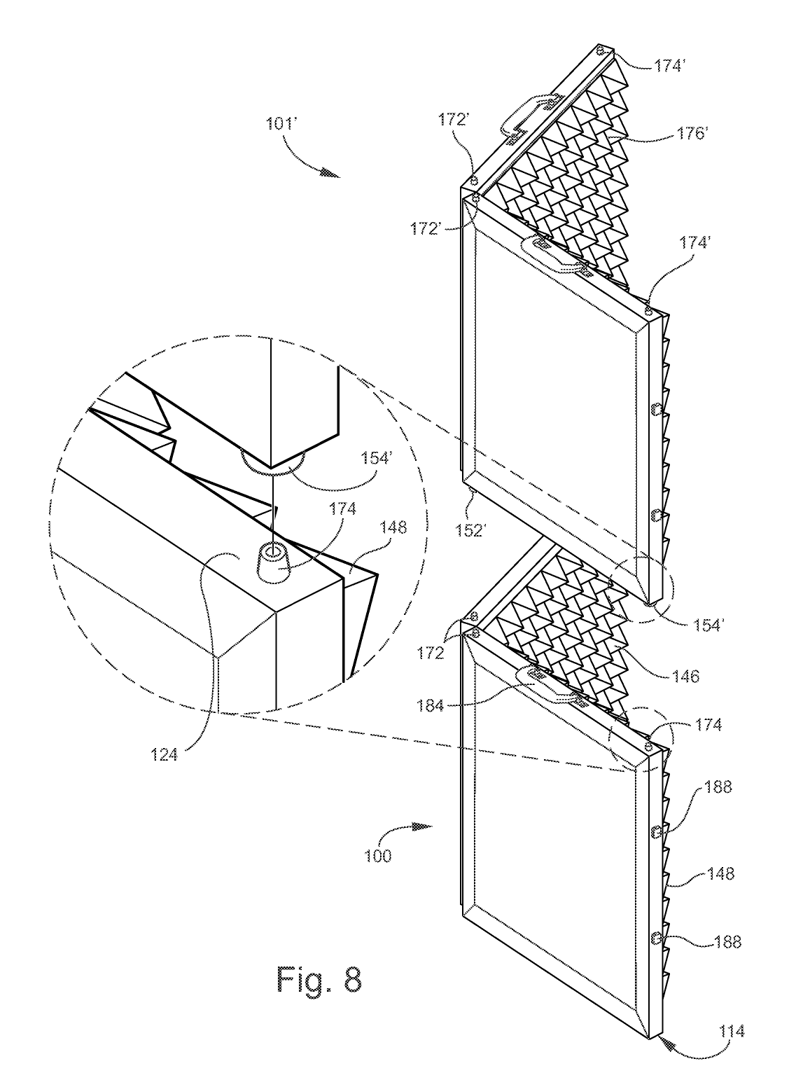

A pair of engaging members 172, 174 can be mounted on each top section 122, 124 of each frame 112, 114. The engaging members can be knobs 172, 174 protruding upwardly from the top sections 122, 124 of the frames 112, 114. Each of the rounded rubber feet 152, 154 attached to the base sections 126, 128 can have a recess formed therein. The knobs 172, 174 on the top sections 122, 124 are sized and positioned to be received in the recesses formed in the feet 152, 154 on the base sections 126, 128. As such, one apparatus 100 can be positioned on top of a second apparatus 100′, and the feet 152, 154 of the first apparatus receive the knobs 172′, 174′ of the second apparatus, as shown in FIG. 8. The complementary engagement of the feet 152, 154 of the upper apparatus 100 and the knobs 172′, 174 of the lower apparatus 100′ stabilizes the upper apparatus 100 to prevent it from falling off of the lower apparatus 100′.

Handles 182, 184, comprised of plastic, rubber or other suitable material, are attached on the top sections 122, 124 of the frames 112, 114. A locking mechanism, such as a pair of nickel plated catch latches 186, 188 are attached at the outer sections 132, 134 of the frames 112, 114, as shown in FIGS. 7 and 9.

The apparatus 100 can be positioned in front of an electric amplifier, as described above in the previous embodiment 10, with the foam sections 146, 148 facing the amplifier to muffle the sound emanating therefrom. The apparatus 100 softens the volume and attack of the sound coming from the electric amplifier for audience members sitting in the direct line of the amplifier, thereby making the performance generally more pleasing for audiences in intimate settings such as restaurants.

When done performing, the user can close the apparatus 100 by folding the panels 102, 104 together, and lock the panels 102, 104 together by engaging the catch latches 186, 188. In this closed/locked condition, the apparatus 100 can be grasped by the handles 182, 184 and easily transported. When needed again for use, the apparatus 100 can be opened by unlatching the latches 186, 188 and moving the panels 102, 104 apart.

A sound muffling apparatus and a method of using same are described above. Various changes can be made to the invention without departing from its scope. The above description of the preferred embodiments and best mode of the invention are provided for the purpose of illustration only and not limitation—the invention being defined by the following claims and equivalents thereof.

What is claimed is:

1. An apparatus for muffling sound comprising:
(a) first and second pivotally connected panels, each of the panels having a front side, a back side opposite the front side, a bottom edge for positioning on a base surface, and a top edge opposite the bottom edge, and wherein the panels are moveable between an open position for use and a closed position for transport; and
(b) a first section of sound dampening material attached to the front side of the first panel, and a second section of sound dampening material attached to the front side of the second panel, wherein the first and second sections of sound dampening material comprise complementary shapes whereby the first and second sections of sound dampening material are positioned against each other in an interlocking arrangement when the panels are in the closed position.

2. An apparatus according to claim 1, further comprising a first foot section functionally connected to the first panel, and a second foot section attached to the second panel, wherein the first and second foot sections extend the base surface to support the panels in an upright position in relation to the base surface.

3. An apparatus according to claim 2, wherein the first foot section is connected to the bottom edge of the first panel, and the second foot section is connected to the bottom edge of the second panel.

4. An apparatus according to claim 3, further comprising a first pair of engaging members positioned on the top edge of the first panel, and a second pair of engaging members positioned on the top edge of the second panel, and wherein each of the first and second foot sections comprise a pair of foot members, each member having a recess formed therein shaped and sized for receiving the engaging members, whereby the apparatus can be positioned on top of a second apparatus and is stabilized by positioning the engaging members of the second apparatus in the recesses of the foot members of the first apparatus.

5. An apparatus according to claim 4, wherein each of the engaging members comprise a round knob, and the recess formed in each of the foot members is round.

6. An apparatus according to claim 1, further comprising a first handle functionally connected to the first panel and a second handle functionally connected to the second panel for a user to grip the apparatus when in the transport position.

7. An apparatus according to claim 6, wherein the first handle is connected to the top edge of the first panel, and the second handle is connected to the top edge of the second panel.

8. An apparatus according to claim 1, wherein the first panel includes an inner side edge, the second panel includes an inner side edge, and the inner side edge of the first panel is pivotally connected to the inner side edge of the second panel.

9. An apparatus according to claim 1, wherein the first and second sections of sound dampening material comprise a sound absorbing foam.

10. An apparatus according to claim 1, wherein the first and second sections of sound dampening material comprise a plurality of foam pyramids positioned wherein the foam pyramids of the first section are in interlocking arrangement with the pyramids of the second section when the panels are in the closed position.

11. An apparatus according to claim 1, further comprising a locking mechanism comprising a first member connected to the first panel, and a second member connected to the second panel whereby the first and second panels can be locked together when in the closed position.

12. An apparatus for muffling sound emanating from an electric amplifier comprising:
(a) first and second pivotally connected panels, each of the panels having a front side, a back side opposite the front side, a bottom edge for positioning on a base surface, and a top edge opposite the bottom edge, and wherein the panels are moveable between an open position for use and a closed position for transport;
(b) a first section of sound dampening material attached to the front side of the first panel, and a second section of sound dampening material attached to front side of the second panel; and
(c) a first handle functionally connected to the first panel for a user to grasp when transporting the apparatus in the closed position.

13. An apparatus according to claim 12, wherein the first and second sections of sound dampening material have complementary shapes whereby the first and second sections of sound dampening material are positioned against each other in an interlocking arrangement when the panels are in the closed position.

14. An apparatus according to claim 13, wherein each of the first and second sections of sound dampening material comprise a plurality of foam pyramids positioned wherein the foam pyramids of the first section are in interlocking arrangement with the pyramids of the second section when the panels are in the closed position.

15. An apparatus according to claim 12, wherein the first section of sound dampening material is attached to the front side of the first panel, and the second section of sound dampening material is attached to the front side of the second panel.

16. An apparatus according to claim 12, further comprising a second handle functionally connected to the second panel.

17. An apparatus according to claim 16, wherein the first handle is connected to the top edge of the first panel, and the second handle is connected to the top edge of the second panel.

18. An apparatus according to claim 12, wherein each of the first and second panels comprise a rectangular metal frame, and a support section contained within the frame, the support section comprised of material selected from the group consisting of plastic, carbon fiber and pressed hardboard.

19. A method for muffling the sound emanating from an electric amplifier comprising the steps of:
(a) providing a sound muffling apparatus comprising:
(i) first and second pivotally connected panels, each of the panels having a front side, a back side opposite the front side, a bottom edge for positioning on a base surface, and a top edge opposite the bottom edge, and wherein the panels are moveable between an open position for use and a closed position for transport;
(ii) a first section of sound dampening material attached to the front side of the first panel, and a second section of sound dampening material attached to the front side of the second panel; and
(iii) a first handle functionally connected to the first panel;
(b) positioning an electric amplifier on a base surface;
(c) positioning the bottom edges of the first and the second panels on the base surface proximate the amplifier, wherein the front side of each of the panels faces the amplifier; and
(d) pivoting the first and second panels to the open position, wherein the front sides of the first and second panels define an angle of less than 180 degrees.

20. A method according to claim 19, further comprising the steps of:
(a) positioning the first panel and the second panel in the closed position, wherein the first and the second sections of sound dampening material are positioned against each other; and
(b) grasping the handle, and transporting the sound muffling apparatus to a desired location.
